(19) United States
(12) Patent Application Publication
(10) Pub. No.: US 2019/0116852 A1
(43) Pub. Date: Apr. 25, 2019

(54) Plant-Based Culinary Creme

(71) Applicant: Rich Products Corporation, Buffalo, NY (US)

(72) Inventors: Daniel Kinkelaar, Buffalo, NY (US); Trupti Palav, Buffalo, NY (US)

(21) Appl. No.: 16/165,021

(22) Filed: Oct. 19, 2018

Related U.S. Application Data
(60) Provisional application No. 62/574,881, filed on Oct. 20, 2017.

(51) Int. Cl. A23L 9/20; A23L 29/212; A23L 11/00; A23L 29/269; A23L 29/238

(52) U.S. Cl. CPC A23L 9/24; A23L 29/212; A23V 2002/00; A23L 29/27; A23L 29/238; A23L 11/05

(57) ABSTRACT

A plant-based culinary crème that includes water, fat, sweetener, plant-based protein, and a dairy-free milk and/or dairy-free milk powder. The plant-based culinary crème does not contain any dairy products. The plant-based culinary crème may be used in hot and/or cold applications. The culinary crème can be used in sauces, soups, pudding (both instant and cooked), smoothies, dressings, and frozen desserts. It provides a crème option for people who cannot or choose not to eat dairy-based products.

The present invention claims priority on U.S. Provisional Application Ser. No. 62/574,881 filed Oct. 20, 2017, which is incorporated herein by reference.

The present disclosure relates to culinary crèmes, and more particularly to plant-based culinary crèmes. The culinary crèmes may be useful in sauces, soups, pudding (instant and cooked), smoothies, dressings, frozen desserts, ice cream, beverages, and other types of food products.

### BACKGROUND OF THE DISCLOSURE

There is a demand for culinary creams, particularly for cooking creams. However, known cooking creams typically contain one or more common allergens such as dairy, wheat, soybeans, eggs, fish, crustacean shellfish, tree nuts, and/or peanuts. Additionally, most culinary creams lack versatility and are only suitable for limited culinary applications.

In view of the current state of the art, there is a need for a plant-based culinary crème that does not contain dairy and is versatile for food processing applications such as boiling, diluting, baking, acidifying, and freezing into a food application. There is also a need for a crème option that can be used in a wide variety of products, such as sauces, soups, pudding (both instant and cooked), smoothies, dressings, and frozen desserts. There is also a need for a vegan culinary crème option.

### SUMMARY OF THE INVENTION

The present invention is directed to a plant-based culinary crème. The plant-based culinary crème in accordance with the present invention includes water, a fat, stabilizer, and a milk or milk powder that is dairy-free (e.g., plant-based milk, a plant-based milk powder, etc.). The culinary crème in accordance with the present invention does not contain any dairy products. The culinary crème in accordance with the present invention can optionally be vegan. The culinary crème in accordance with the present invention can be formulated to thicken when used in hot applications and/or can be formulated to be refrozen into a frozen soft serve. The cooking crème in accordance with the present invention can be formulated to be used for many or any application in which heavy cream is used, as is, or diluted for half and half or whole milk applications such as, but not limited to, smoothies, instant pudding bases, ice cream, salad dressings, chocolate ganache. The culinary crème in accordance with the present invention can optionally be lower in saturated fat and/or cholesterol as compared to standard dairy-based crèmes. The culinary crème in accordance with the present invention forms an unstable emulsion (e.g., matrix or foam) when whipped, thus reverts back to its liquid form after being whipped or vigorously stirred. The culinary crème in accordance with the present invention is formulated to be baked, boiled, sautéed, and diluted for pudding or beverage applications including smoothies. The culinary crème in accordance with the present invention is formulated so that it can be acidified for salad dressing applications, and can be frozen into ice cream dessert applications.

The water content of the culinary crème of the present invention is about 30-88 wt. % (and all values and ranges therebetween). In one non-limiting embodiment, the culinary crème of the present invention includes about 35-85 wt. % water. In one non-limiting embodiment, the culinary crème of the present invention includes about 40-60 wt. % water. In another non-limiting embodiment, the culinary crème of the present invention includes about 45-58 wt. % water. In another non-limiting embodiment, the culinary crème of the present invention includes about 50-54 wt. %© water. In one non-limiting embodiment, the water content of the culinary crème of the present invention is greater than 50 wt. %. The water content in the culinary crème of the present invention is generally greater than any other component in the crème. In one non-limiting embodiment, the weight percent ratio of water to fat content in the culinary crème of the present invention is 1.2-8.8:1 (and all values and ranges therebetween), typically 1.5-8.1:1, and more typically 2-8.1:1. In another non-limiting embodiment, the weight percent ratio of water to sweetener in the culinary crème of the present invention is about 1.5-1100:1 (and all values and ranges therebetween), typically 2-1100:1, and more typically, 2.5-1100:1. In another non-limiting embodiment, the weight percent ratio of water to dairy-free milk and/or a dairy-free milk powder is 4-30:1, typically 5-26:1, and more typically 5-25:1.

The fat content of the culinary crème of the present invention is about 3-40 wt. % (and all values and ranges there between). In one non-limiting embodiment, the culinary crème of the present invention about 5-40 wt. % fat. In another non-limiting embodiment, the culinary crème of the present invention includes about 10-35 wt. % fat. In another non-limiting embodiment, the culinary crème of the present invention includes about 20-30 wt. % fat. In another non-limiting embodiment, the culinary crème of the present invention includes about 22-28 wt. % fat. The fat in the culinary crème of the present invention can include a single type of fat or be a combination of one or more types of fats. The fat may be a liquid, solid, or semi-solid at room temperature. The fat is generally not solid at room temperature (i.e., 77° F.), and is typically a liquid at room temperature. Typically, the fat is a plant-based fat and excludes any type of fat from an animal. Specifically, the liquid can be comprised of one or more oils derived from a plant source. The plant-based oil(s) may be selected from, but not limited to, vegetable oil, palm kernel oil, olive oil, corn oil, canola oil, grape seed oil, avocado oil, soy oil, safflower oil, sunflower oil, peanut oil, coconut oil, rice bran oil, flax oil, palm oil, and sesame oil. In one non-limiting embodiment, the fat in the culinary crème of the present invention includes canola oil (e.g., 10.5 wt. % canola oil, 20 wt. % canola oil, 25 wt. % canola oil, etc.). In another non-limiting embodiment, the fat in the culinary crème of the present invention includes canola oil and coconut oil and wherein the canola oil content is greater than the coconut oil content. In another non-limiting embodiment, the fat in the culinary crème of the present invention includes palm kernel oil (e.g., 25 wt. % palm kernel oil, etc.). In another non-limiting embodiment, the fat in the culinary crème of the present invention includes a blend of palm kernel oil and palm oil (20 wt. % blend of palm kernel oil and palm oil, etc.) and wherein the amount of palm kernel oil constitutes no more than 50% of the total fat content of the culinary crème of the present invention, and typically when palm kernel oil when used, constitutes less than 50%© of the total fat content. When the culinary crème of the present invention includes saturated fat, the total content of the saturated fat is no more than 50% of the total fat content of the culinary crème of the present invention, and typically less than 50% of the total fat content of the culinary crème of the present invention. In one non-limiting embodiment, the fat in the crème is trans-fat free.

The dairy-free milk or dairy-free milk powder content of the culinary crème of the present invention is about 1-20 wt. % (and all values and ranges therebetween). In one embodiment, the culinary crème of the present invention includes about 2-15 wt. % dairy-free milk and/or dairy-free milk powder. In another non-limiting embodiment, the culinary crème of the present invention includes about 3-12 wt. % dairy-free milk and/or dairy-free milk powder. In another non-limiting embodiment, the culinary crème of the present invention includes about 3-10 wt. % dairy-free milk and/or dairy-free milk powder. The milk and/or milk powder can be derived from milk from grains, legumes, nuts, seeds, plants, etc. In another non-limiting embodiment, the dairy-free milk or dairy-free milk powder includes at least one of almond milk powder, almond milk, soy milk powder, soy milk, rice milk powder, rice milk, coconut milk powder, coconut milk, hemp milk powder, hemp milk, oat milk powder, oat milk, potato milk powder, potato milk, hazelnut milk powder, hazelnut milk, cashew milk powder, cashew milk, flax milk powder, flax milk, sunflower milk powder, sunflower milk, macadamia milk powder, macadamia milk, pea milk powder, pea milk, pumpkin seed milk powder, pumpkin seed milk, barley milk powder, barley milk, sunflower seed milk powder, sunflower seed milk, dairy-free yeast-derived milk powder and/or dairy-free yeast-derived milk. In another non-limiting embodiment, the milk powder in the culinary crème of the present invention includes rice milk powder, rice milk, pumpkin seed milk, pumpkin seed milk powder, coconut milk, and/or coconut powder.

The culinary crème of the present invention includes one or more stabilizers. The one or more stabilizers are present in an amount of from about 0.01-14 wt. % (and all values and ranges therebetween). In one non-limiting embodiment, the culinary crème of the present invention includes 0.01-10 wt. % stabilizer(s). In another non-limiting embodiment, the culinary crème of the present invention includes 0.05-8 wt. % stabilizer(s). In another non-limiting embodiment, the culinary crème of the present invention includes 0.05-6 wt. % stabilizer(s). In another non-limiting embodiment, the culinary crème of the present invention includes 0.05-5 wt. % stabilizer(s). In another non-limiting embodiment, the culinary crème of the present invention includes 0.05-4 wt. % stabilizer(s). In another non-limiting embodiment, the culinary crème of the present invention includes 0.05-3 wt. % stabilizer(s). In another non-limiting embodiment, the culinary crème of the present invention includes 0.05-2 wt. % stabilizer(s). In another non-limiting embodiment, the culinary crème of the present invention includes 0.05-1 wt. % stabilizer(s). The stabilizer can include one or more starches, and/or can include one or more hydrocolloids and/or gums. The one or more starches (when used) can be modified starches, non-modified starches, or a combination thereof. Non-limiting examples of modified starches that can be included in the culinary crème of the present invention include modified corn starch, modified tapioca starch, dextrin, acid-treated starch, alkaline-treated starch, bleached starch, oxidized starch, starches-enzyme-treated, mono starch phosphate, distarch phosphate, phosphated distarch phosphate, acetylated distarch phosphate, starch acetate, acetylated distarch adipate, hydroxypropyl starch, hydroxypropyl distarch phosphate, hydroxypropyl distarch glycerol, starch sodium octenyl succinate, and acetylated oxidized starch. Non-limiting examples of starch sources include arrowroot starch, corn starch, tapioca starch, potato starch, sago starch, soy starch, maize starch, and sweet potato starch. In one non-limiting embodiment, the starch includes modified corn starch. In another non-limiting embodiment, the starch in the crème includes modified corn starch and/or modified tapioca starch. The one or more hydrocolloids and/or gums (when used) can be natural, such as vegetable, or synthetic gums and may be, for example, carrageenan, guar gum, alginate, xanthan gum, locust bean gum, arabic gum, gellan gum, pectin, and the like, or semi-synthetic, such as methylcellulose, carboxy-methylcellulose, ethylcellulose, hydroxy-propylmethylcellulose (HPMC), and microcrystalline cellulose. In one non-limiting embodiment, the stabilizer in the crème includes one or more of rice extract, xanthan gum, gum arabic, locust bean gum, and guar gum. In another non-limiting embodiment, the stabilizer in the crème includes two or more of rice extract, xanthan gum, gum arabic, locust bean gum, and guar gum. When starch and hydrocolloids and/or gums are included in the crème, the starch content is generally greater than the content of the hydrocolloids and/or gums; however, this is not required.

The culinary crème of the present invention optionally includes one or more plant-based proteins. The content of the one or more plant-based proteins of the culinary crème of the present invention is about 0-5 wt. % (and all values and ranges therebetween). In one non-limiting embodiment, the culinary crème of the present invention includes about 0.05-3.5 wt. % plant-based protein. In another non-limiting embodiment, the culinary crème of the present invention includes about 0.1-3 wt. % plant-based protein. In another non-limiting embodiment, the culinary crème of the present invention includes about 0.25-2 wt. % plant-based protein. In another non-limiting embodiment, the culinary crème of the present invention includes about 0.5-1.2 wt. % plant-based protein. In one non-limiting embodiment, the plant-based protein is absent nut-based protein. In another non-limiting embodiment, the plant-based protein is or includes one or more plant-based protein powders. Non-limiting examples of plant-based protein powders include pea protein, rice protein, maca protein, chia protein, flax protein, hemp protein, potato protein, chickpea protein, pumpkin seed protein, quinoa protein, artichoke protein, and soy protein. In another non-limiting embodiment, the plant-based protein in the crème includes at least 0.01 wt. % pea protein, chickpea protein, pumpkin seed protein, and/or rice protein.

The culinary crème of the present invention optionally includes one or more sweeteners/bulking agents. The sweetener/bulking agent content of the culinary crème of the present invention is about 0-30 wt. % (and all values and ranges therebetween). In one non-limiting embodiment, the culinary crème of the present invention includes 0.05-30 wt. % sweetener and/or bulking agent. In another one non-limiting embodiment, the culinary crème of the present invention includes about 6-21 wt. % sweetener and/or bulking agent. In another non-limiting embodiment, the culinary crème of the present invention includes about 10-19 wt. % sweetener and/or bulking agent. In another non-limiting embodiment, the culinary crème of the present invention includes 12-17 wt. % sweetener and/or bulking agent. The sweetener in the crème of the present invention (when used) generally includes one or more types of sweetener (e.g., monosaccharides, disaccharides, polysaccharides, etc.). Specifically, the sweetener can be comprised of one or more sugars (e.g., sucrose, fructose, dextrose, maltodextrin, or glucose); sugar syrups (e.g., rice syrup, corn syrup, glucose syrup, maple syrup, golden syrup, high-fructose corn syrup, etc.); polyols (e.g., maltitol, sorbitol, xylitol, erythritol, isomalt, etc.) and/or intensive sweeteners, such as aspartame, acetosulfame, alitame, saccharin, cyclamates, and trichloro sucrose. In one non-limiting embodiment, the sweetener in the culinary crème of the present invention (when used) includes sugar, rice syrup and/or rice syrup powder. The bulking agent(s) can be used to increase viscosity and/or enhance freeze-thaw stability of the culinary crème of the present invention. In one non-limiting embodiment, the bulking agent (when used) includes one or more compounds of maltodextrin, dietary fiber (e.g. polysaccharides and lignin), polydextrose, sugar alcohols or polyols, inulin and fructooligosaccharides. In one non-limiting embodiment, the bulking agent in the crème includes maltodextrin.

The culinary crème of the present invention optionally includes one or more emulsifiers. The one or more emulsifiers (when used) are present in an amount of from about 0-5 wt. % (and all values and ranges therebetween). In one non-limiting embodiment, the culinary crème of the present invention includes 0.1-2 wt. % emulsifier(s). In another non-limiting embodiment, the culinary crème of the present invention includes 0.2-1 wt. % emulsifier(s). In another non-limiting embodiment, the crème includes 0.3-0.5 wt. % emulsifier(s). Non-limiting examples of the emulsifiers that can be used include glycerol monostearate, polyoxyethylene ethers of sorbitan monostearate (polysorbate 60) and polyoxyethylene ethers of sorbitan monooleate (polysorbate 80); span-20, span-40, span-60, span-80; lecithin; hydroxylated lecithin; mono-, di-, or polyglycerides of fatty acids, such as stearin and palmitin mono and diglycerides; polyoxyethylene ethers of fatty esters of polyhydric alcohols, or the polyoxyethylene ethers of sorbitan distearate; fatty esters of polyhydric alcohols such as sorbitan monostearate; polyglycerol esters of mono and diglycerides such as hexaglyceryl distearate; mono- and diesters of glycols such as propylene glycol ester, propylene glycol monostearate, and propylene glycol monopalmitate, succinoylated monoglycerides; and the esters of carboxylic acids such as lactic, citric, and tartaric acids with the mono- and diglycerides of fatty acids such as glycerollacto palmitate and glycerollacto stearate, and calcium or sodium stearoyl lactylates and all members of the sucrose ester family thereof; all varieties of diacetyltartaric esters of fatty acids; esters of sorbitol (e.g., sorbitan tristearate, etc.); glycerol and fatty acids mixtures (e.g., polyglycerol polyricinoleate, etc.); “DATEMS”, and the like, and mixtures thereof. Polysorbates are oily liquids derived from ethoxylated sorbitan (a sorbitol derivative) esterified with fatty acids. In some embodiments, the polysorbate is selected from polysorbate 20 (polyoxyethylene (20) sorbitan monolaurate), polysorbate 40 (polyoxyethylene (20) sorbitan monopalmitate), polysorbate 60 (polyoxyethylene (20) sorbitan monostearate), polysorbate 80 (polyoxyethylene (20) sorbitan monooleate), and mixtures of one or more of the enumerated polysorbates. In some particular embodiments, the polysorbate is polysorbate 60, also known as 2-[2-[3,4-bis(2-methoxyethoxy)oxolan-2-yl]-2-(2-methoxyethoxy)ethoxy]ethyl octadecanoate. In one non-limiting embodiment, the emulsifier in the culinary crème of the present invention includes mono- and/or diglycerides, propylene glycol ester, and/or propylene glycol monostearate.

The culinary crème of the present invention optionally includes one or more buffers. The one or more buffers (when used) are present in an amount of from about 0-5 wt. % (and all values and ranges therebetween). In one non-limiting embodiment, the culinary crème of the present invention includes 0.1-3 wt. % buffer(s). In another non-limiting embodiment, the culinary crème of the present invention includes 0.2-2 wt. % buffer(s). In another non-limiting embodiment, the culinary crème of the present invention includes 0.25-1 wt. % buffer(s). In another non-limiting embodiment, the culinary crème of the present invention includes 0.3-0.6 wt. % buffer(s). The buffer helps maintain the pH of the crème within a desired range. Non-limiting buffers include sodium citrate, calcium citrate, potassium citrate, monopotassium phosphate, potassium tartrate, disodium phosphate, calcium carbonate, aluminum potassium sulfate, aluminum sodium sulfate, aluminum ammonium sulfate, ammonium adipate, ammonium carbonate, ammonium dihydrogen phosphate, ammonium phosphate, dibasic, ammonium phosphate, monobasic, calcium dl-malate, calcium gluconate, calcium hydroxide, calcium phosphate, monobasic, calcium pyrophosphate, diammonium hydrogen phosphate, dicalcium pyrophosphate, disodium hydrogen phosphate, disodium pyrophosphate, magnesium dl-lactate, magnesium gluconate, potassium dihydrogen citrate, potassium dihydrogen phosphate, potassium phosphate, dibasic, potassium phosphate, monobasic, sodium acetate, sodium acetate, anhydrous, sodium acid pyrophosphate, sodium adipate, sodium citrate, sodium dihydrogen citrate, sodium dihydrogen phosphate, sodium hydrogen dl-malate, sodium phosphate, dibasic, sodium phosphate, monobasic, sodium phosphate, tribasic, sodium potassium tartrate, sodium pyrophosphate, sodium sesquicarbonate, succinic acid, tetrapotassium pyrophosphate, triammonium citrate, tripotassium citrate, tripotassium phosphate, trisodium phosphate, and trisodium citrate. In one non-limiting embodiment, the buffer in the crème includes disodium phosphate, disodium phosphate anhydrous, sodium citrate dihydrate, calcium carbonate and/or trisodium citrate.

The culinary crème of the present invention optionally includes one or more flavoring agents. The one or more flavoring agents (when used) are present in an amount of from about 0-4 wt. % (and all values and ranges therebetween). In one non-limiting embodiment, the culinary crème of the present invention includes 0.001-2 wt. % flavoring agent(s). In another non-limiting embodiment, the culinary crème of the present invention includes 0.005-1 wt. % flavoring agent(s). In another non-limiting embodiment, the culinary crème of the present invention includes 0.01-0.5 wt. % flavoring agent(s). In another non-limiting embodiment, the culinary crème of the present invention includes 0.015-0.25 wt. % flavoring agent(s). Non-limiting examples of flavoring agents include salt, half & half-type cream flavoring, vanilla flavoring, cream flavoring, chocolate flavoring, coffee flavoring, maple flavoring, spice flavoring, mint flavoring, butter flavoring, caramel flavoring, and fruit flavoring. In one non-limiting embodiment, the flavoring agent in the crème includes salt and/or half & half-type cream flavoring.

The culinary crème of the present invention optionally includes one or more vitamins and/or minerals. The content of the one or more vitamins and/or minerals is up to 1 wt. %

Non-limiting example formulations of the culinary crème of the present invention are provided in the following tables wherein the numbers are weight percentages based on the weight of the composition:

| Ingredient | Example 1 | Example 2 | Example 3 | Example 4 | Example 5 |
|---|---|---|---|---|---|
| Water | 30-70 | 35-65 | 40-60 | 40-56 | 45-55 |
| Fat | 3-40 | 5-35 | 5-30 | 8-28 | 10-26 |
| Sweetener/bulking | 0-30 | 0.5-30 | 1-25 | 2-20 | 5-20 |
| agent | | | | | |
| Dairy-free milk | 1-20 | 1-15 | 2-12 | 3-10 | 4-8 |
| and/or dairy-free | | | | | |
| milk powder | | | | | |
| Plant-based protein | 0-5 | 0-4 | 0-3.5 | 0.1-3.5 | 0.1-3.5 |
| Emulsifier | 0-5 | 0-3 | 0-2 | 0-1.6 | 0-1 |
| Buffer | 0-5 | 0-3 | 0-2 | 0-1 | 0-0.6 |
| Flavoring agent | 0-4 | 0-2 | 0-1 | 0-0.5 | 0-0.25 |
| Stabilizer | 0.01-7 | 0.05-6 | 0.05-4 | 0.06-3 | 0.09-2 |
| Vitamins/Minerals | 0-1 | 0-0.5 | 0-0.2 | 0-0.1 | 0-0.05 |

| Ingredient | Example 6 | Example 7 | Example 8 | Example 9 | Example 10 |
|---|---|---|---|---|---|
| Water | 30-70 | 40-60 | 45-58 | 50-56 | 51-55 |
| Fat (Non-Animal- | 3-40 | 15-32 | 18-30 | 19-28 | 12-26 |
| based) | | | | | |
| Sweetener/bulking | 0-30 | 6-21 | 8-19 | 9-18 | 10-17.5 |
| agent | | | | | |
| Dairy-free milk | 1-15 | 3-10 | 4-9 | 5-8 | 5.5-10 |
| and/or dairy-free | | | | | |
| milk powder | | | | | |
| Plant-Based Protein | 0.01-5 | 0.1-3 | 0.25-2 | 0.5-1 | 0.5-2 |
| Emulsifier | 0-5 | 0.1-2 | 0.2-1.5 | 0.2-1 | 0-0.9 |
| Buffer | 0-5 | 0.1-3 | 0.2-2 | 0.2-1 | 0.2-0.8 |
| Flavoring agent | 0-4 | 0.01-2 | 0.05-1 | 0.1-0.5 | 0-0.25 |
| Starch | 0.01-5 | 0.01-2 | 0.05-1 | 0.07-0.4 | 0.09-0.2 |
| Hydrocolloids | 0.01-10 | 0.01-6 | 0.05-1 | 0.07-0.4 | 0.09-0.2 |
| and/or gums | | | | | |
| Vitamins/Minerals | 0-1 | 0-0.5 | 0-0.2 | 0-0.1 | 0.01-0.5 |

| Ingredient | Example 11 | Example 12 | Example 13 | Example 14 |
|---|---|---|---|---|
| Water | 30-70 | 40-60 | 45-58 | 50-53 |
| Canola Oil | 15-35 | 18-32 | 20-30 | 21-26 |
| Rice syrup or rice syrup powder | 5-21 | 7-19 | 9-17 | 10-15 |
| Rice milk powder or coconut milk | 1-20 | 2-18 | 3-10 | 4-8 |
| powder | | | | |
| Pea protein, pumpkin seed protein | 0-5 | 0.1-3 | 0.25-2 | 0.45-1 |
| and/or other vegetable protein | | | | |
| Propylene glycol ester | 0-2.5 | 0.05-1 | 0.1-0.5 | 0.15-0.35 |
| Mono- & diglycerides | 0-2.5 | 0.05-1 | 0.1-0.5 | 0.15-0.35 |
| Sodium citrate dihydrate | 0-2 | 0.01-1 | 0.05-0.5 | 0.1-0.3 |
| Disodium phosphate anhydrous | 0-2 | 0.01-1 | 0.03-0.3 | 0.05-0.2 |
| Calcium carbonate | 0-2 | 0.01-1 | 0.05-0.5 | 0.1-0.3 |
| Modified corn starch | 0-2 | 0.01-1 | 0.03-0.3 | 0.05-0.2 |
| Corn starch | 0-2 | 0.05-1 | 0.1-0.5 | 0.15-0.4 |
| Flavoring | 0-2 | 0.01-1 | 0.05-0.3 | 0.1-0.2 |
| Salt | 0-2 | 0.01-1 | 0.03-0.2 | 0.05-0.15 |
| Maltodextrin | 0-10 | 1-8 | 1.5-6 | 2-5 |
| Rice extract | 0-1 | 0.01-0.3 | 0.02-0.2 | 0.03-0.1 |
| Xanthan gum | 0-1 | 0.01-0.2 | 0.02-0.1 | 0.02-0.07 |
| Guar gum | 0-1 | 0.01-0.2 | 0.02-0.1 | 0.03-0.09 |

| Ingredient | Example 15 | Example 16 | Example 17 | Example 18 |
|---|---|---|---|---|
| Water | 30-70 | 40-60 | 45-58 | 50-53 |
| Canola Oil | 12-35 | 15-30 | 16-28 | 17-25 |
| Rice syrup or rice syrup powder | 5-22 | 5-20 | 6-15 | 8-12 |
| Rice milk powder | 1-20 | 2-18 | 3-10 | 4-8 |
| Chickpea protein | 0-5 | 0.1-3 | 0.25-2 | 0.45-1 |
| Lecithin | 0-2 | 0.01-1.5 | 0.05-1 | 0.1-0.4 |
| Dipotassium phosphate anhydrous | 0-2 | 0.01-1 | 0.03-0.5 | 0.05-0.3 |
| Calcium carbonate | 0-2 | 0.01-1 | 0.05-0.8 | 0.1-0.5 |
| Tapioca starch | 0-2 | 0.05-1 | 0.1-0.5 | 0.15-0.4 |
| Flavoring | 0-2 | 0.01-1 | 0.05-0.3 | 0.1-0.2 |
| Salt | 0-2 | 0.01-1 | 0.03-0.2 | 0.05-0.15 |
| Maltodextrin | 0-15 | 1-10 | 1.5-8 | 2-6 |
| Rice extract | 0-1 | 0.01-0.3 | 0.02-0.2 | 0.03-0.1 |
| Arabic gum | 0.1-10 | 0.5-8 | 1-7 | 2-6 |
| Xanthan gum | 0-1 | 0.01-0.2 | 0.02-0.1 | 0.02-0.07 |
| Guar gum | 0-1 | 0.01-0.2 | 0.02-0.1 | 0.03-0.09 |

| Ingredient | Example 19 | Example 20 | Example 21 | Example 22 |
|---|---|---|---|---|
| Water | 30-70 | 45-62 | 49-58 | 52-55 |
| Canola Oil | 6-30 | 7-27 | 8-25 | 10-23 |
| Coconut Oil | 0.5-9.5 | 1-9 | 2-8 | 2-7 |
| Rice syrup or rice syrup powder | 3-19 | 5-17 | 7-15 | 9-13 |
| Rice milk powder | 1-15 | 4-11 | 5-9 | 6-8 |
| Maltodextrin | 0-10 | 1-5 | 1.5-4 | 2-3 |
| Pea protein and/or rice protein | 0.01-5 | 0.1-3 | 0.2-2.8 | 0.3-2.3 |
| Propylene glycol monostearate | 0-2.5 | 0.05-1 | 0.1-0.5 | 0.15-0.25 |
| Mono- & diglycerides | 0-2.5 | 0.05-1 | 0.1-0.5 | 0.15-0.25 |
| Trisodium citrate | 0-2 | 0.01-1 | 0.05-0.5 | 0.1-0.2 |
| Disodium phosphate | 0-2 | 0.01-1 | 0.03-0.8 | 0.05-0.6 |
| Calcium carbonate | 0-2 | 0-1 | 0.05-0.5 | 0.1-0.25 |
| Modified corn starch | 0-2 | 0-1 | 0-0.3 | 0.05-0.2 |
| Potato starch | 0-2 | 0.1-1 | 0.2-0.8 | 0-0.6 |
| Half & half-type cream flavoring | 0-2 | 0.01-1 | 0.05-0.3 | 0.1-0.2 |
| Salt | 0-2 | 0.01-1 | 0.03-0.2 | 0.05-0.1 |
| Rice extract | 0-1 | 0.01-0.1 | 0.02-0.1 | 0.03-0.05 |
| Xanthan gum | 0-2 | 0-1 | 0-0.1 | 0.03-0.07 |
| Guar gum | 0-2 | 0-1 | 0-0.1 | 0.03-0.07 |
| Gum Arabic | 0-6 | 0.1-5 | 0.5-5 | 0-4.6 |

Examples 1-22 are non-limiting examples of culinary crème of the present invention that is formulated to be homogenized and then frozen for later use after being defrosted.

| Ingredient | Example 23 | Example 24 | Example 25 | Example 26 |
|---|---|---|---|---|
| Water | 60-88 | 65-88 | 66-87 | 68-86 |
| Fat | 3-30 | 3-27 | 3-26 | 3-25 |
| Sweetener/bulking agent | 0-15 | 0-10 | 0.02-8 | 0.05-3 |
| Dairy-free milk and/or dairy-free | 2-20 | 2-15 | 2-10 | 2-5 |
| milk powder | | | | |
| Plant-based protein | 0-5 | 0-4 | 0-3 | 0-2 |
| Emulsifier | 0-5 | 0-4 | 0-4 | 0-2 |
| Buffer | 0-5 | 0-4 | 0-2 | 0-1 |
| Flavoring agent | 0-5 | 0-3 | 0-2 | 0-1 |
| Stabilizer | 0.02-2 | 0.03-1.5 | 0.04-1 | 0.05-0.8 |
| Vitamins/Minerals | 0-1 | 0-0.5 | 0-0.2 | 0-0.1 |

| Ingredient | Example 27 | Example 28 | Example 29 | Example 30 |
|---|---|---|---|---|
| Water | 62-87 | 66-86 | 68-85 | 70-87 |
| Fat (Non-Animal-based) | 4-28 | 3-26 | 3-25 | 3-23 |
| Sweetener/bulking agent | 0-12 | 0-8 | 0.01-7 | 0.02-3 |
| Dairy-free milk and/or dairy-free | 2-18 | 2.5-12 | 2.5-9 | 3-5 |
| milk powder | | | | |
| Plant-based protein | 0-4.5 | 0-3.5 | 0-2.5 | 0.2-1 |
| Emulsifier | 0-4 | 0-3.5 | 0-3.5 | 0.1-1 |
| Buffer | 0-4 | 0-3 | 0-2.5 | 0.1-1 |
| Flavoring agent | 0-2 | 0-1 | 0-1 | 0-0.8 |
| Starch | 0-1.8 | 0-1.4 | 0-1.1 | 0.01-0.6 |
| Hydrocolloids and/or gums | 0.01-2 | 0.01-2 | 0.02-2 | 0.05-2 |
| Vitamins/Minerals | 0-0.8 | 0-0.4 | 0-0.2 | 0-0.1 |

| Ingredient | Example 31 | Example 32 | Example 33 | Example 34 | Example 35 |
|---|---|---|---|---|---|
| Water | 70-85 | 68-80 | 70-82 | 80-88 | 65-72 |
| Canola oil | 8-14 | 15-25 | 12-20 | 1-7 | 20-30 |
| Coconut oil | 0-10 | 0-8 | 1-8 | 0-4 | 0-10 |
| Sugar | 0.02-0.15 | 0.02-0.2 | 0.02-0.3 | 1-7 | 0.02-0.2 |
| Rice milk powder | 2-5 | 2-5 | 2-6 | 2-6 | 2-5 |
| Pea protein, | 0.1-1 | 0.1-1.1 | 0.1-0.8 | 2-4.2 | 0.2-0.7 |
| chickpea protein, | | | | | |
| and/or rice protein | | | | | |
| Lecithin | 0.05-0.5 | 0.05-0.5 | 0.05-0.4 | 0.05-0.3 | 0.1-0.5 |
| Disodium | 0.01-0.6 | 0.01-0.5 | 0.01-0.5 | 0.01-0.4 | 0.01-0.3 |
| phosphate | | | | | |
| anhydrous | | | | | |
| Calcium carbonate | 0.01-1 | 0.01-0.8 | 0.01-0.5 | 0.01-0.6 | 0.01-0.3 |
| Potato starch | 0.1-1 | 0.1-0.8 | 0.1-0.9 | 0.05-0.5 | 0.05-0.6 |
| Flavoring | 0.001-0.1 | 0.001-0.1 | 0.001-0.1 | 0.001-0.1 | 0.001-0.1 |
| Salt | 0.01-0.5 | 0.01-0.6 | 0.01-0.4 | 0.01-0.4 | 0.01-0.3 |
| Locust bean gum | 0.01-0.2 | 0.01-0.3 | 0.01-0.25 | 0.01-0.25 | 0.01-0.2 |
| Xanthan gum | 0.01-1 | 0.01-0.8 | 0.02-0.5 | 0.02-0.3 | 0.02-0.2 |
| Guar gum | 0.01-1 | 0.01-0.8 | 0.01-0.6 | 0.01-0.4 | 0.01-0.3 |
| Vitamins/Minerals | 0-0.1 | 0.001-0.1 | 0-0.1 | 0-0.1 | 0-0.1 |

Examples 23-25 are non-limiting examples of a culinary crème of the present invention that is formulated to be treated by UHT/HTST treatments so that such culinary crème is shelf-stable.

In a non-limiting embodiment of the invention, there is provided a method for making and using a plant-based culinary crème that includes the steps of:

A. Form water slurry by blending water, dairy-free milk or dairy-free milk powder, optionally sweetener/bulking agent, optionally a stabilizer, and optionally a starch;

B. Form oil slurry by blending a fat source, optionally an emulsifier, optionally a flavoring agent, and optionally a buffering agent;

C. Mix water slurry and oil slurry to form a first mixture;

D. Homogenize the first mixture;

E. Cool homogenized mixture;

F. Optionally freeze cooled mixture;

G. Optionally defrost frozen mixture; and

H. Use mixture (optionally after being defrosted) in a culinary application.

In a non-limiting embodiments of the invention, there is provided a method for making and using a plant-based culinary crème that includes the steps of:

A. Heat fat source;

B. Add plant-based protein and optionally add bulking agent, emulsifier, buffering agent, and stabilizer to heated fat source to form a first mixture;

C. Add sweetener, dairy-free milk or dairy-free milk powder, water and starch to form first mixture;

D. Add flavoring agent to first mixture to form second mixture;

E. Homogenize second mixture;

F. Cool homogenized composition;

G. Optionally freeze cooled composition;

H. Optionally thaw frozen composition; and

I. Use composition (optionally after being thawed) in a culinary application.

In another and/or alternative non-limiting objective of the present invention, there is the provision of a vegan, plant-based culinary crème.

In another and/or alternative non-limiting objective of the present invention, there is the provision of a plant-based culinary crème that is ready to eat.

In another and/or alternative non-limiting objective of the present invention, there is the provision of a rice- and/or pea-based culinary crème; however, it can be appreciated that the culinary crème can also include other grains, legumes or plant-based milks and/or proteins.

In another and/or alternative non-limiting objective of the present invention, there is the provision of a plant-based culinary crème that does not contain dairy milk or other dairy products.

In another and/or alternative non-limiting objective of the present invention, there is the provision of a plant-based culinary crème that does not contain wheat or derivatives thereof.

In another and/or alternative non-limiting objective of the present invention, there is the provision of a plant-based culinary crème that does not contain soybeans or soybean derivatives.

In another and/or alternative non-limiting objective of the present invention, there is the provision of a plant-based culinary crème that does not contain eggs or materials derived from eggs.

In another and/or alternative non-limiting objective of the present invention, there is the provision of a plant-based culinary crème that does not contain fish or materials derived from fish.

In another and/or alternative non-limiting objective of the present invention, there is the provision of a plant-based culinary crème that does not contain shellfish (e.g., crustacean shellfish) or materials derived therefrom.

In another and/or alternative non-limiting objective of the present invention, there is the provision of a plant-based culinary crème that does not contain tree nuts.

In another and/or alternative non-limiting objective of the present invention, there is the provision of a plant-based culinary crème that does not contain peanuts.

In another and/or alternative non-limiting objective of the present invention, there is the provision of a plant-based culinary crème that is not whippable. As such, the plant-based culinary crème forms an unstable emulsion (foam) when whipped, thus reverts back to its liquid form within about 0.05-5 minutes (and all values and ranges therebetween) after being whipped or vigorously stirred. Generally, the plant-based culinary crème reverts back to its liquid form after being whipped or vigorously stirred within about 0.05-5 minutes (and all values and ranges therebetween).

In another and/or alternative non-limiting objective of the present invention, there is the provision of a plant-based culinary crème that is lower in saturated fat relative to dairy-based creams.

In another and/or alternative non-limiting objective of the present invention, there is the provision of a plant-based culinary crème that is lower in cholesterol relative to dairy-based creams.

In another and/or alternative non-limiting objective of the present invention, there is the provision of a plant-based culinary crème that thickens in hot applications.

In another and/or alternative non-limiting objective of the present invention, there is the provision of a plant-based culinary crème that can be frozen into a soft serve.

In another and/or alternative non-limiting objective of the present invention, there is the provision of a plant-based culinary crème that can be used for any applications in which heavy cream is used.

In another and/or alternative non-limiting objective of the present invention, there is the provision of a plant-based culinary crème that is freeze-thaw stable.

In another and/or alternative non-limiting objective of the present invention, there is the provision of a plant-based culinary crème that can be boiled.

In another and/or alternative non-limiting objective of the present invention, there is the provision of a plant-based culinary crème that can be diluted.

In another and/or alternative non-limiting objective of the present invention, there is the provision of a plant-based culinary crème that can be baked.

In another and/or alternative non-limiting objective of the present invention, there is the provision of a plant-based culinary crème that can be acidified.

In another and/or alternative non-limiting objective of the present invention, there is the provision of a plant-based culinary crème that can be frozen into a dessert application.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating an exemplary method in accordance with some embodiments of the present disclosure.

FIG. 2 is a flow chart illustrating another exemplary method in accordance with some embodiments of the present disclosure.

### DESCRIPTION OF NON-LIMITING EMBODIMENTS

The present invention is directed to a plant-based culinary crème. The culinary crème may be useful in sauces, soups, pudding (instant and cooked), smoothies, dressings, frozen desserts, ice cream, beverages, and other types of food products.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.”

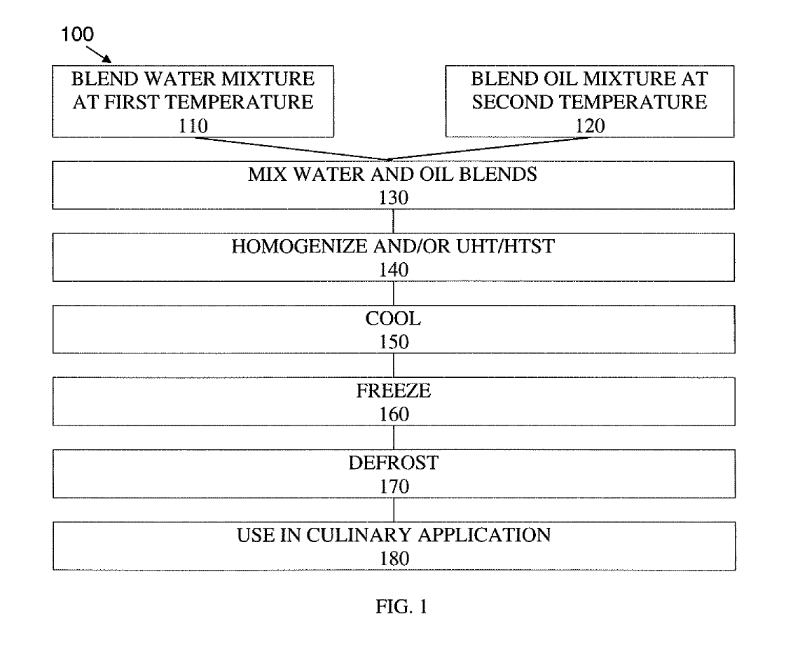

FIG. 1 illustrates one non-limiting example of a method 100 for making a culinary crème in accordance with the present disclosure. The method 100 includes blending a water mixture at a first temperature 110. The water mixture includes water, dairy-free milk or dairy-free milk powder, plant-based protein, optionally sweetener/bulking agent, optionally a stabilizer, and optionally a starch. The method 100 further includes blending an oil mixture at a second temperature 120. The oil mixture includes a fat source not derived from an animal, optionally an emulsifier, optionally a flavoring agent, and optionally a buffer. The blending of the water mixture and oil mixture may be performed simultaneously or sequentially in either order. In one non-limiting embodiment, the first temperature exceeds the second temperature. The first temperature may be in the range of about 140-200° F., including from about 170-190° F. The second temperature may be in the range of about 110-170° F., including from about 130-150° F. The first temperature may exceed the second temperature by 20-60° F., including from about 30-50° F. The method 100 further includes combining the water and oil mixtures 130. The composition that is formed by the combining of the water and oil mixtures is held at a third temperature for a first time period. The third temperature can be 140-190° F., including from about 150-180° F. In one non-limiting embodiment, the first time period is about 30 seconds to about 20 minutes. In another non-limiting embodiment, the first time period is about 1-10 minutes. The method further includes homogenizing the composition 140. The homogenization may be performed at a first pressure. In one non-limiting embodiment, the first pressure is about 500-2000 psi. In another non-limiting embodiment, the first pressure is about 750-1250 psi. The homogenized composition is cooled to a fourth temperature 150. In one non-limiting embodiment, the fourth temperature is about 30-60° F. In another non-limiting embodiment, the fourth temperature is about 35-50° F. In one non-limiting embodiment, the cooling is achieved with a plate exchanger. The homogenized composition is thereafter frozen for storage or transportation 160. The composition can later be used after being thawed or defrosted 170 for a period of time (e.g., 3-48 hours thawing time, etc.). In another non-limiting embodiment, the defrosting period is about 12-48 hours. In another non-limiting embodiment, the defrosting period is about 10-30 hours. Once the composition is defrosted or thawed, the composition can be used as a crème in various culinary applications 180.

The shelf life of the composition in a refrigerated environment (33-45° F.) or non-refrigerated environment (70-80° F.) is extended as compared to typical cooking cream compositions. Generally, the shelf life of the composition in a refrigerated environment and an unopened container is at least one month, typically at least two months, more typically at least six months, at still more typically at least twelve months. Generally, the shelf life of the composition in a non-refrigerated environment and an unopened container is at least two weeks, typically at least one month, more typically at least two months, at still more typically at least six months.

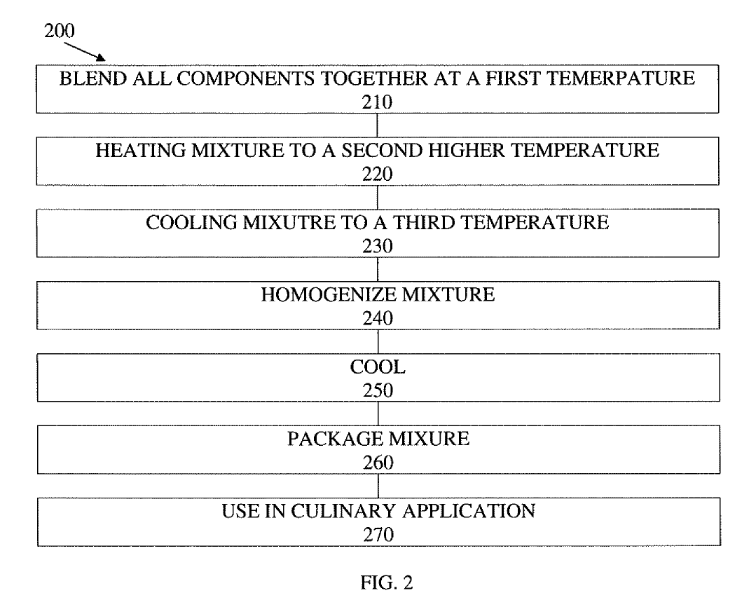

FIG. 2 illustrates another non-limiting example of a method 200 for making and packaging a culinary crème using a UHT/HTST. The method 200 includes blending all of the components of the composition together at first temperature 210. In one non-limiting embodiment, the first temperature is about 100-200° F. In another non-limiting embodiment, the first temperature is from about 140-190° F. In one non-limiting embodiment, the blending occurs for a time period in the range of about 30 second to about 15 minutes. In another non-limiting embodiment, the time period is about 1-5 minutes. Thereafter, the mixture is heated to a second higher temperature 220. In another non-limiting embodiment, the second temperature exceeds the first temperature by about 15-100° F. In another non-limiting embodiment, the second temperature is in the range of about 200-300° F. In another non-limiting embodiment, the second temperature is in the range of about 240-290° F. The heating time at the second high temperature is greater than 2 seconds generally less than 5 minutes. In one non-limiting embodiment, the heating time at the second high temperature is about 3-60 seconds. After heating at the second temperature, the mixture is cooled to a third temperature 230. In one non-limiting embodiment, the third temperature is about 100-200° F. After the mixture is cooled to the third temperature, the mixture is homogenized 240. The homogenization may be performed at a pressure is in the range of about 500-2000 psi. In another non-limiting embodiment, the pressure for homogenization is in the range of about 500-1000 psi. After homogenization, the mixture is cooled to a fourth temperature 250 and then filled into an aseptic package 260. The packaged composition is shelf stable in ambient temperatures (e.g., 77°) for at least six (6) months. The composition can be used directly from the packaging as a crème in various culinary applications 270.

The following examples are provided to illustrate the compositions, methods, and systems of the present disclosure. The examples are merely illustrative and is not intended to limit the disclosure to the materials, conditions, or process parameters set forth therein.

### EXAMPLE 1

One non-limiting example of a culinary crème has the composition described in the following table. (Values in wt. %)

| Ingredient | Ex. A | Ex. B |
|---|---|---|
| Canola oil (fat) | 20-30% | 22-27% |
| Propylene glycol monostearate (emulsifier) | 0.08-0.4% | 0.12-0.25% |
| Modified corn starch (stabilizer) | 0.03-0.3% | 0.075-0.15% |
| Modified tapioca starch (stabilizer) | 0.08-0.4% | 0.12-0.25% |
| Rice milk powder reduced fiber (dairy-free | 3-7.5% | 4.8-6.1% |
| milk powder) | | |
| Maltodextrin (bulking agent) | 1-5% | 1.8-3% |
| Rice syrup (sweetener) | 8-18% | 10-14% |
| Half & half-type cream flavoring (flavor) | 0.03-0.3% | 0.075-0.18% |
| Water | 45-60% | 48-55% |
| Pea protein (protein source and texturizer) | 0.3-1.5% | 0.7-1.3% |
| Trisodium citrate (buffer) | 0.05-0.3% | 0.075-0.2% |
| Modified rice extract (stabilizer) | 0.01-0.1% | 0.02-0.07% |
| Mono- & diglycerides (emulsifier) | 0.08-0.4% | 0.14-0.28% |
| Xanthan gum (stabilizer) | 0.01-0.2% | 0.03-0.08% |
| Salt (flavor) | 0.01-0.2% | 0.03-0.1% |
| Di sodium phosphate (buffer) | 0.05-0.3% | 0.075-0.15% |
| Calcium carbonate (buffer) | 0.05-0.3% | 0.075-0.19% |
| Guar gum (stabilizer) | 0.01-0.2% | 0.03-0.08% |
| Batch Total | 100.00 | 100.00 |

In 180° F. water, rice milk powder, maltodextrin, the gums, buffer, plant-based protein, and the starches were blended. In 140° F. oil, the remaining ingredients were blended. The liquid slurry and the oil slurry were combined and held at 165° F. for 3 minutes prior to homogenization at 1000 psi. The homogenized composition was cooled to 42° F. using a plate heat exchanger. The cooled crème was frozen. From the frozen state, the crème could be moved to refrigeration and defrosted (e.g., for 24 hours). The defrosted composition could be shaken and used in a desired culinary application. The crème is not a stable whippable product, thus reverts back to its liquid form in less than 5 minutes if the crème is whipped or vigorously stirred.

### EXAMPLE 2

Another non-limiting example of a culinary crème has the composition described in the following table. (Values in wt. %)

| Ingredient | Ex. C | Ex. D |
|---|---|---|
| Non-hydrogenated coconut oil (fat) | 1-9.5% | 3-7% |
| Canola oil (fat) | 12-30% | 17-22% |
| Propylene glycol monostearate (emulsifier) | 0.05-0.4% | 0.12-0.27% |
| Modified corn starch (stabilizer) | 0.02-0.3% | 0.05-0.15% |
| Rice milk powder reduced fiber (dairy-free | 3-9% | 4.5-7.5% |
| milk powder) | | |
| Maltodextrin (bulking agent) | 0.8-4% | 2-3% |
| Rice syrup powder (sweetener) | 5-16% | 8-13% |
| Half & half-type cream flavoring (flavor) | 0.03-0.3% | 0.08-0.18% |
| Water | 45-62% | 50.1-55% |
| Pea protein (protein source and texturizer) | 0.1-2% | 0.5-0.9% |
| Trisodium citrate (buffer) | 0.05-0.4% | 0.12-0.2% |
| Modified rice extract (stabilizer) | 0.01-0.18% | 0.02-0.06% |
| Mono- and diglycerides (emulsifier) | 0.05-0.5% | 0.12-0.25% |
| Xanthan gum (stabilizer) | 0.01-0.18% | 0.02-0.08% |
| Salt (flavor) | 0.01-0.18% | 0.04-0.1% |
| Disodium phosphate (buffer) | 0.03-0.3% | 0.08-0.18% |
| Calcium carbonate (buffer) | 0.03-0.3% | 0.08-0.18% |
| Guar gum (stabilizer) | 0.01-0.18% | 0.02-0.08% |
| Batch Total | 100.00 | 100.00 |

The crème was prepared by adding the oils to a mixer and heating to a minimum of 140° F. Next, the premix was added and blended in for 3 minutes. The premix included maltodextrin, pea protein, the emulsifiers, the buffering agents, and the stabilizers. Next, water was added and the mixture was blended and heated to 165° F. Next, rice syrup, rice milk, and starch were added. The mixture was agitated with a high sheer mixer while maintaining the temperature at 165° F. The flavoring agents were added and blended in for 3 minutes prior to further processing. Next, the composition was homogenized and cooled to 40° F. Optionally, the homogenized composition could be stored frozen and thawed prior to use. The crème is heat stable and acid stable and could be used to prepare sauces, dressings, and soups. The crème is not a stable whippable product, and reverts back to its liquid form in less than 5 minutes if the crème is whipped or vigorously stirred, and typically reverts back to its liquid form in less than 4 minutes if the crème is whipped or vigorously stirred, and more typically reverts back to its liquid form in less than 3 minutes if the crème is whipped or vigorously stirred.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

What is claimed:

1. A plant-based culinary crème that is absent dairy products comprising a) 30-88 wt. % water, b) 3-40 wt. % fat, c) 0.01-14 wt. % stabilizer, and d) 1-20 wt. % dairy-free milk and/or dairy-free milk powder.

2. The plant-based culinary crème as defined in claim 1, wherein said fat is a plant-based fat.

3. The plant-based culinary crème as defined in claim 1, wherein said fat includes one or more of vegetable oil, palm kernel oil, olive oil, corn oil, canola oil, grape seed oil, avocado oil, safflower oil, sunflower oil, peanut oil, coconut oil, rice bran oil, flax oil, palm oil, and/or sesame oil.

4. The plant-based culinary crème as defined in claim 1, wherein said dairy-free milk and/or dairy-free milk powder includes one or more of almond milk powder, almond milk, soy milk powder, soy milk, rice milk powder, rice milk, coconut milk powder, coconut milk, hemp milk powder, hemp milk, oat milk powder, oat milk, potato milk powder, potato milk, hazelnut milk powder, hazelnut milk, cashew milk powder, cashew milk, flax milk powder, flax milk, sunflower milk powder, sunflower milk, macadamia milk powder, macadamia milk, pea milk powder, pea milk, pumpkin seed milk powder, pumpkin seed milk, barley milk powder, barley milk, sunflower seed milk powder, sunflower seed milk, dairy-free yeast-derived milk powder and/or dairy-free yeast-derived milk.

5. The plant-based culinary crème as defined in claim 1, wherein said stabilizer includes one or more of modified plant extract, starch, hydrocolloid and/or gum.

6. The plant-based culinary crème as defined in claim 5, wherein said stabilizer includes one or more of rice extract, xanthan gum, gum arabic, locust bean gum, and/or guar gum.

7. The plant-based culinary crème as defined in claim 1, further including plant-based protein, a content of said plant-base protein in said plant-based culinary crème is up to 5 wt. %.

8. The plant-based culinary crème as defined in claim 7, wherein said plant-based protein includes one or more of pea protein, rice protein, maca protein, chia protein, flax protein, hemp protein, potato protein, chickpea protein, pumpkin seed protein, quinoa protein, artichoke protein, and/or soy protein.

9. The plant-based culinary crème as defined in claim 1, further including sweetener/bulking agent, a content of said sweetener/bulking agent in said plant-based culinary crème is up to 30 wt. %.

10. The plant-based culinary crème as defined in claim 9, wherein said sweetener/bulking agent including one or more of sugar, sugar syrup, polyol, intensive sweetener, maltodextrin, dietary fiber, polydextrose, sugar alcohol, inulin and/or fructooligosaccharides.

11. The plant-based culinary crème as defined in claim 1, further including emulsifier, a content of said emulsifier in said plant-based culinary crème is up to 5 wt. %.

12. The plant-based culinary crème as defined in claim 11, wherein the emulsifier includes one or more of propylene glycol monostearate, lecithin, propylene glycol ester, monoglycerides, and/or diglycerides.

13. The plant-based culinary crème as defined in claim 1, further including buffer, a content of said buffer in said plant-based culinary crème is up to 5 wt. %.

14. The plant-based culinary crème as defined in claim 13, wherein said buffer includes one or more of sodium citrate dihydrate, trisodium citrate, disodium phosphate, disodium phosphate anhydride, and/or calcium carbonate.

15. The plant-based culinary crème as defined in claim 1, wherein the plant-based culinary crème does not comprise a) wheat or wheat derivatives, b) soybeans or soybean derivatives, c) eggs or egg derivatives, d) fish or fish derivatives, e) shellfish or shellfish derivatives, dairy products and/or dairy derivative products, and/or g) nuts or nut derivatives.

16. The plant-based culinary crème as defined in claim 1, wherein the plant-based culinary crème does not form a stable whippable emulsion, and reverts back to liquid form in less than 5 minutes after being whipped or vigorously stirred.

17. The plant-based culinary crème as defined in claim 1, comprising:
about 30 wt. % to about 70 wt. % water;
about 3 wt. % to about 40 wt. % of a fat;
about 0 wt. % to about 30 wt. % of a sweetener/bulking agent;
about 1 wt. % to about 20 wt. % of a dairy-free milk or a dairy-free milk powder;
up to about 5 wt. % of a plant-based protein;
up to about 5 wt. % of an emulsifier;
up to about 5 wt. % of a buffer;
up to about 4 wt. % of a flavoring agent;
up to about 0.01-7 wt. % of a stabilizer; and,
up to about 1 wt. % vitamins/minerals.

18. The plant-based culinary crème as defined in claim 1, comprising:
about 60 wt. % to about 88 wt. % water;
about 3 wt. % to about 30 wt. % of a fat;
about 0 wt. % to about 15 wt. % of a sweetener/bulking agent;
about 2 wt. % to about 20 wt. % of a dairy-free milk or a dairy-free milk powder;
up to about 5 wt. % of a plant-based protein;
up to about 5 wt. % of an emulsifier;
up to about 5 wt. % of a buffer;
up to about 5 wt. % of a flavoring agent;
up to about 0.02-2 wt. % of a stabilizer; and,
up to about 1 wt. % vitamins/minerals.

19. A method for making a plant-based culinary crème, the method comprising:
blending a dairy-free milk and/or dairy-free milk powder, and a stabilizer, in water at a first temperature to form a water slurry, said dairy-free milk or dairy-free milk powder including plant-based milk and/or plant-based milk powder, said stabilizer including modified plant extract, starch, hydrocolloid and/or gum;
providing oil slurry that includes fat at a second temperature, said fat includes a plant-based fat;
mixing the water slurry and the oil slurry at a third temperature to form a mixture; and,
homogenizing and/or UHT/HTST treating said mixture.

20. The method as defined in claim 19, wherein said water slurry includes a bulking agent.

21. The method as defined in claim 19, wherein said oil slurry includes sweetener, emulsifier, plant-based protein, flavoring agent, and/or buffering agent.

22. The method as defined in claim 19, further including the step of freezing said mixture.

23. The method as defined in claim 19, wherein the first temperature is in the range of about 140-200° F.

24. The method as defined in claim 19, wherein the second temperature is in the range of about 110-170° F.

25. The method as defined in claim 19, wherein the third temperature is in the range of about 140-190° F.

26. The method as defined in claim 19, wherein the mixture is homogenized at a pressure in the range of about 500-2000 psi.

27. A method for making a plant-based culinary crème, the method comprising:
blending a dairy-free milk and/or dairy-free milk powder, a stabilizer, water and fat at a first temperature to form a mixture;
heating said mixture to second higher temperature;
cooling said mixture to a third temperature;
homogenizing said mixture; and
packaging said mixture.
